(19) United States
(12) Patent Application Publication
(10) Pub. No.: US 2002/0140893 A1
(43) Pub. Date: Oct. 3, 2002

(54) Method for fabricating a spacer for liquid crystal display

(75) Inventors: Jong-Hoon Yi, Seoul-shi (KR); Jeong-Hyun Kim, Gyeonggi-do (KR)

Correspondence Address: MORGAN, LEWIS & BOCKIUS LLP, 1800 M Street, N.W., Washington, DC, 20036, US

(73) Assignee: LG.PHILIPS LCD CO., LTD

(21) Appl. No.: 10/029,208

(22) Filed: Dec. 28, 2001

(30) Foreign Application Priority Data
Apr. 3, 2001 (KR) 10-2001-0017649

(51) Int. Cl. G02F 1/1339

(52) U.S. Cl. 349/155

(57) ABSTRACT

A method of fabricating a spacer for a liquid crystal display device includes steps of forming a transparent electrode on a substrate, forming an orientation film on the transparent electrode, and forming a dot-shaped spacer on the orientation film by spraying a material through an inkjet nozzle.

This application claims the benefit of Korean Patent Application No. 10-2001-0017649, filed on Apr. 3, 2001, which is hereby incorporated by reference.

### BACKGROUND OF THE INVENTION

1. Field of the Invention

The present invention relates to a liquid crystal display (LCD) device, and more particularly, to a method for the fabrication of an LCD device with spacers.

2. Description of the Related Art

Until recently, the cathode-ray tube (CRT) has been mainly developed and used for display devices. However, flat panel displays are beginning to be developed because of their small depth dimensions, desirably low weight, and low voltage power supply requirements. Presently, thin film transistor-liquid crystal displays (TFT-LCDs) with high resolution and small depth dimension have been developed.

FIG. 1 shows a conventional liquid crystal display device.

In FIG. 1, the LCD device is composed of upper and lower substrates 5 and 22. A black matrix 6, a color filter 7, which includes a sub-color filter (red, green, blue) 8, and a transparent common electrode 18, which is disposed above the color filter, are formed on the upper substrate 5. A pixel region P, a pixel electrode 17, which is disposed on the pixel region, and an array line, which includes a switching device T, are formed on the lower substrate 22. A liquid crystal layer 14 is interposed between the upper and lower substrates 5 and 22.

The lower substrate 22 is commonly referred to as an array substrate, where thin film transistors T are arranged in a matrix configuration, and gate and data lines 13 and 15 that cross the thin film transistors T are formed. The pixel region P is defined by the gate and data lines 13 and 15, and a transparent conductive metal like indium-tin-oxide (ITO), for example, whose transmittance is relatively high, is used as pixel electrode 17 on the pixel region P.

FIG. 2 is a fabrication flowchart of the conventional LCD device shown in FIG. 1.

In FIG. 2, at step st1, the lower substrate is prepared by forming an array of thin film transistors and pixel electrodes thereon.

At step st2, the orientation layer is formed on the lower substrate. Formation of the orientation layer includes deposition of a polymeric material thin film on an entire surface of the lower substrate and a uniform rubbing process is subsequently performed. Generally, an organic material, such as polyimide, for example, is used as the orientation film. The rubbing process scours the orientation layer along one direction by using a cloth, thereby aligning the liquid crystal molecules along the rubbing direction. The rubbing process determines the initial array orientation of the liquid crystal, and supplies the normal operation of the liquid crystal and the uniform characteristic of the display.

At step st3, a printing process of the seal pattern is performed. The seal patterning process involves forming a desired pattern by application of a thermosetting plastic. A common process is the screen-printing method. The seal pattern of the liquid crystal layer serves two functions: forming a gap for liquid crystal material injection and confining the injected liquid crystal material.

At step st4, a process of spraying spacers is performed. A specific size of the spacer used in the fabrication process of the liquid crystal cell determines and maintains a precise and uniform gap between the upper and lower substrates. Accordingly, the spacers are sprayed evenly onto the lower substrate. The spray method can be divided into two different types: a wet spray method that involves spraying a mixture of alcohol and spacer material and a dry spray method of spraying that involves only spraying of the spacer material. Furthermore, the dry spray method can be sub-divided into two different types: an electrostatic spray method that uses electrostatic force and a non-electric spray method that uses gas pressure. The non-electric spray method is mainly used when the liquid crystal cell structure is susceptible to damage from static electricity.

At step st5, an attachment process of the upper substrate (color filter substrate) and the lower substrate (thin film transistor array substrate) is performed. The alignment of the upper and lower substrates is determined by a given margin of each substrate design. In general, accuracy within a few μm is required. If the alignment margin is exceeded, the liquid crystal cell will not operate adequately due to light leakage.

At step st6, a cutting process of the liquid crystal cell is performed to create unit cells. Generally, several unit liquid crystal cells are formed on a large sized glass substrate and then divided by this cutting process. In the fabrication process of the initial liquid crystal display device, the unit cells are separated after simultaneous injection of the liquid crystal material into the several cells. However, injection of liquid crystal material is commonly performed after a large sized liquid crystal cell is cut into several unit cells due to an increase of the cell size. The cell cutting process includes a scribe process that forms cutting lines on a surface of the substrate using a diamond pen, a hardness of which is higher than a hardness of the glass substrate, and a break process that divides the cells by force.

At step st7, a step of liquid crystal material injection into unit liquid crystal cells is performed. The unit liquid crystal cell has a size of several hundreds of square centimeters with a gap of several micrometers. Accordingly, a vacuum injection method is commonly used as an effective injection method.

Although standardized spacers are commonly used in the spray process, the spray method has many limitations resulting from the spraying itself. Therefore, patterning spacers have been widely investigated instead of spraying spacers. For example, a method of patterning spacers by using a resin disposed on an upper substrate is explained with reference to FIGS. 3A to 3G.

In FIG. 3A, a black matrix 6 is formed on a transparent insulating substrate 5. Generally, the black matrix 6 is formed between red/green/blue patterns (sub-color filters) and is formed to screen light that transmits a reverse tilt domain around a boundary of a pixel electrode 17 (FIG. 1). A metal thin film such as chromium (Cr) or an organic material of the carbon family having an optical density of more than 3.5 is commonly used as a material with which to form the black matrix (6). Alternatively, the black matrix may comprise a double layer structure of chromium (Cr)/chromium-oxide (CrOx) to lower reflection. Moreover, the material with which to form the black matrix 6 is commonly chosen depending on products available. Additionally, a region 17a for formation of a color filter is etched to have smaller area than an area of corresponding pixel electrodes 17 (FIG. 1).

In FIG. 3B, a color filter using a color resin of red/green/blue is formed. The main constituents of the color resin are a photo polymerization initiation material, a photo polymerization type photosensitive composition material, and a organic pigment that has red/green/blue or similar colors. Initially, after a red color resin is deposited on an entire surface of the substrate 5, which has a black matrix pattern 6, a red sub-color filter 8a is formed within a desired region by selective exposure. Although the sequence of the color resin is red, green, blue, any ordered sequence may be arbitrary chosen. Next, after a green color resin is deposited on the entire surface of the substrate 5 that has the red color filter 8a, a green color filter 8b is formed by selective exposure. Finally, after a blue color resin is deposited on the entire surface of the substrate 5 that has the red and green color filters Sa and 8b, a blue color filter 8c is formed by selective exposure.

In FIG. 3C, a planarization process of the surface of the substrate that has the sub-color filters is performed. For the planarization process of the substrate 5 that has the sub-color filters 8a, 8b and 8c, an overcoat layer 26 is formed on the substrate 5 by deposition of a transparent resin that has insulating properties.

In FIG. 3D, a process of forming an electrode on the color filter is performed. In general, when using the color filter substrate 5 as the upper substrate of the liquid crystal display panel, the transparent electrode 18 is formed on top of the color filter substrate 5. The transparent electrode 18 (also called the common electrode) will be used to drive the liquid crystal layer 14 with a pixel voltage. The common electrode 18 is formed by deposition a transparent conductive material including indium-tin oxide (ITO) or indium-zinc-oxide (IZO), which have high transparence, on the overcoat layer 26, and subsequent patterning of the transparent conductive material.

In FIG. 3E, a process of forming spacers is performed. A transparent organic film is formed on the common electrode 18, and spacers 20 having a definite height are formed through photolithographic and etching processes.

In FIG. 3F, a process of forming an orientation film 22 is performed. An organic insulating material, such as polyimide, for example, is deposited over the spacers 20 and the surface of the common electrode 18. Subsequently, a process of rubbing the orientation film 22 is performed.

In general, although the method of patterning the spacers after formation of the orientation film can be considered, the lower orientation film may be damaged by any chemical solution used in the process of patterning the spacer 20. However, if the upper substrate is fabricated according to the conventional method, rubbing defects of the orientation film can be generated at corresponding portions of the spacers during the rubbing process of the orientation film 22.

FIG. 4 is a plane view of defects of an inferior crystal display. (The figure shows only the spacer and the light leakage phenomenon.) If the orientation film 22 is formed after the patterning of the spacers 20 as mentioned above, the rubbing direction 24 of the orientation film 22 can be minutely misaligned during the rubbing process because of the rough shape of the spacer 20 formed on the surface. Since the liquid crystal material is injected after attaching the upper substrate A (FIG. 3F) to the lower substrate, the pre-tilt angle of the liquid crystal molecules at the misalign position differs from that of other positions. If the liquid crystal display panel is driven, a dim shadow or light leakage phenomenon will occur since orientation characteristics of the liquid crystal molecules near the spacer 20 differ from the orientation characteristics of other positions, thereby decreasing the quality of the liquid crystal display panel.

### SUMMARY OF THE INVENTION

Accordingly, the present invention is directed to a spacer fabrication method of the liquid crystal display device that substantially obviates one or more of the problems due to limitations and disadvantages of the related art.

An object of the present invention is to simplify a fabrication process of a liquid crystal display panel and to improve the quality of the liquid crystal display panel by using an inkjet method for spacer fabrication.

Another object of the present invention is to provide liquid crystal display devices with an improved fabrication process.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of fabricating a spacer for a liquid crystal display device includes steps of forming a transparent electrode on a substrate, forming an orientation film on the transparent electrode and forming a spacer on the orientation film by spraying a material through an inkjet nozzle.

In another aspect, a color filter substrate includes a substrate, a black matrix and a sub-color filter formed on the substrate, a transparent electrode formed on the black matrix and the sub-color filter, an orientation film on the transparent electrode, and a spacer formed on the orientation film, wherein an upper surface of the spacer is convex.

In another aspect, a method of fabricating a color filter substrate includes steps of forming a sub-color filter and a black matrix on a substrate, forming a transparent electrode on the sub-color filter and the black matrix, forming an orientation film on the transparent electrode, and forming a spacer on the orientation film by spraying material through an inkjet nozzle.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective view of a conventional liquid crystal display panel;

FIG. 2 is a flow chart showing a fabrication sequence of a conventional liquid crystal display panel;

FIGS. 3A to 3F are schematic cross-sectional views taken along III-III of FIG. 1 according to the conventional fabrication process;

FIG. 4 is a schematic plane view of a display defect while driving a conventional liquid crystal display panel;

FIGS. 5A to 5E are schematic cross-sectional views taken along III-III of FIG. 1 according to an exemplary fabrication process according to the present invention;

FIG. 6 is a schematic plane view of an exemplary liquid crystal display panel fabricated according to the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or the like parts.

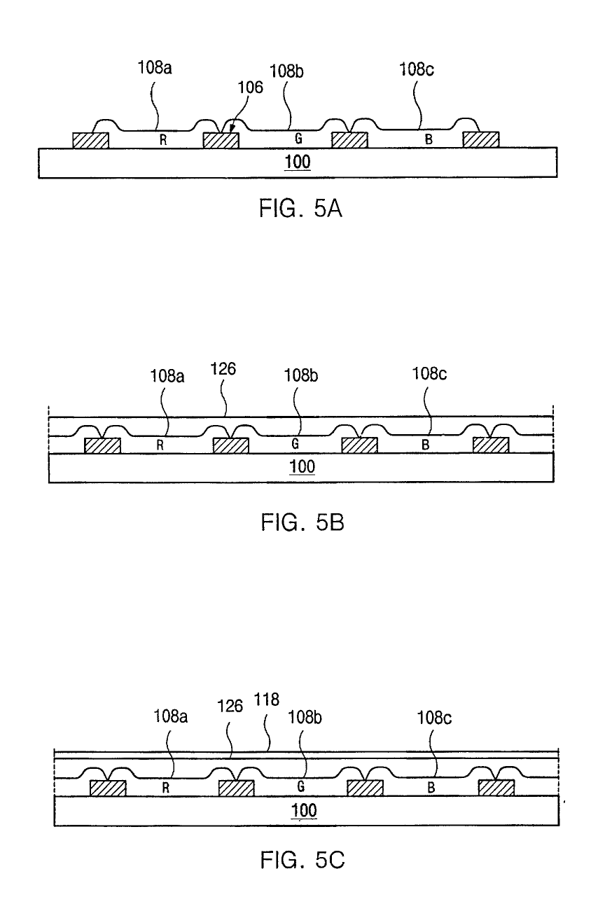

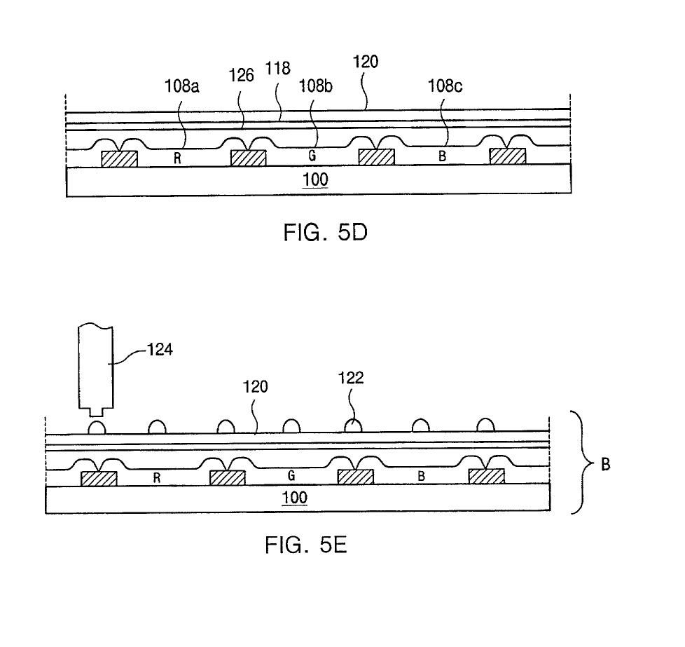

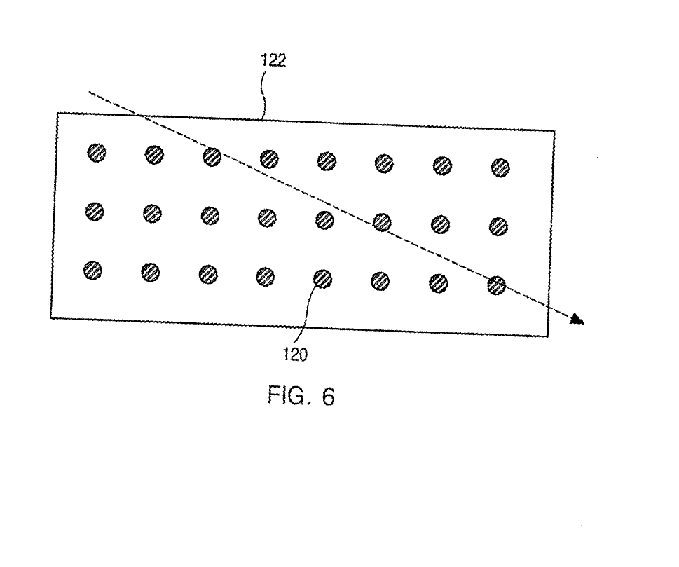

FIGS. 5A to 5E show an exemplary fabrication process of a color filter substrate according to the present invention.

In FIG. 5A, a black matrix 106 and red/green/blue sub-color filters 108a, 108b and 108c may be formed on a transparent insulating substrate 100.

In FIG. 5B, a planarization process of the surface of the substrate may be performed by deposition of a transparent resin, thereby forming an overcoat layer 126.

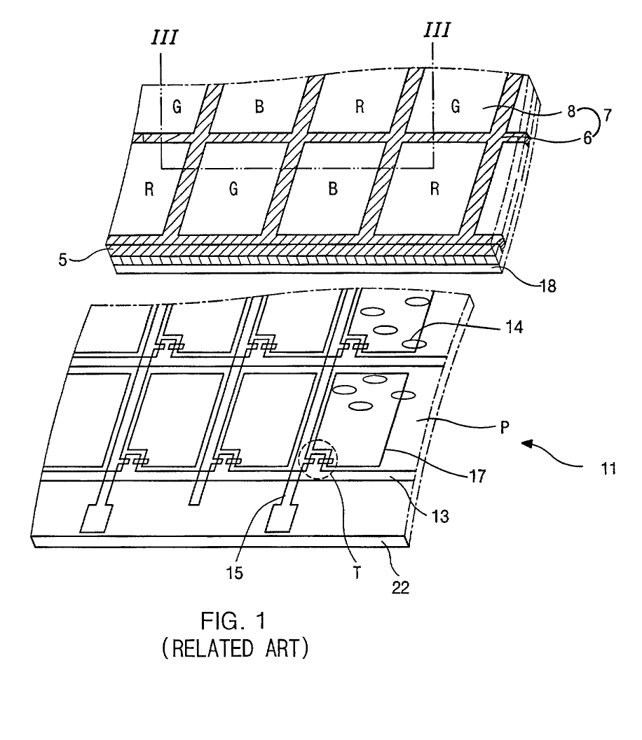

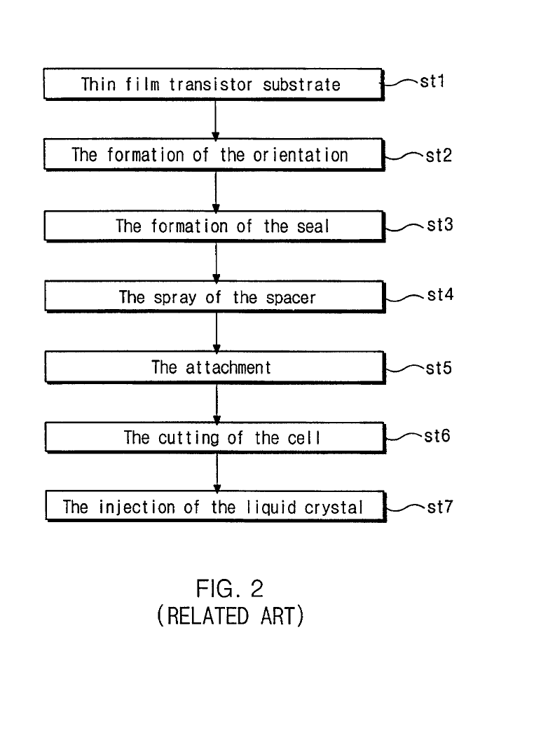

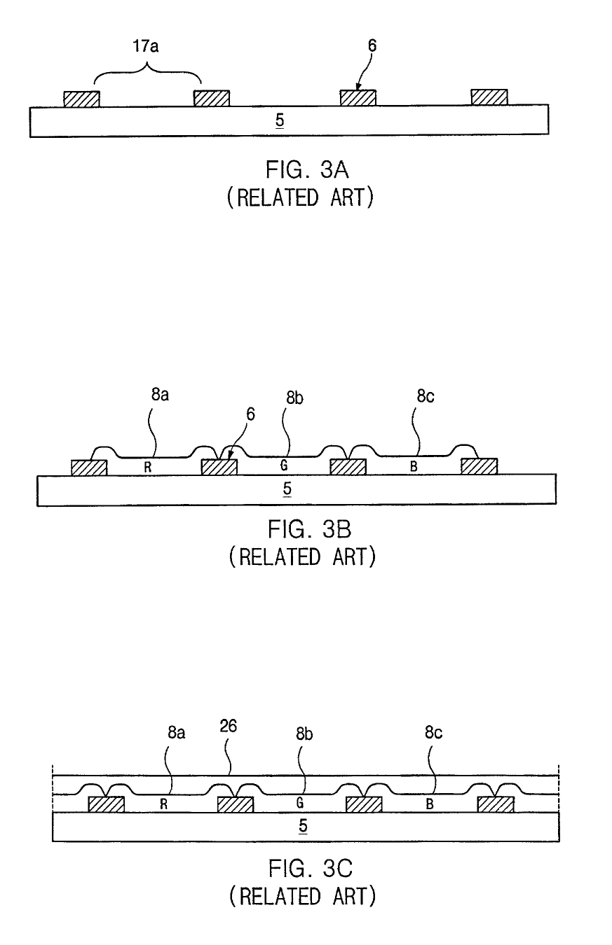

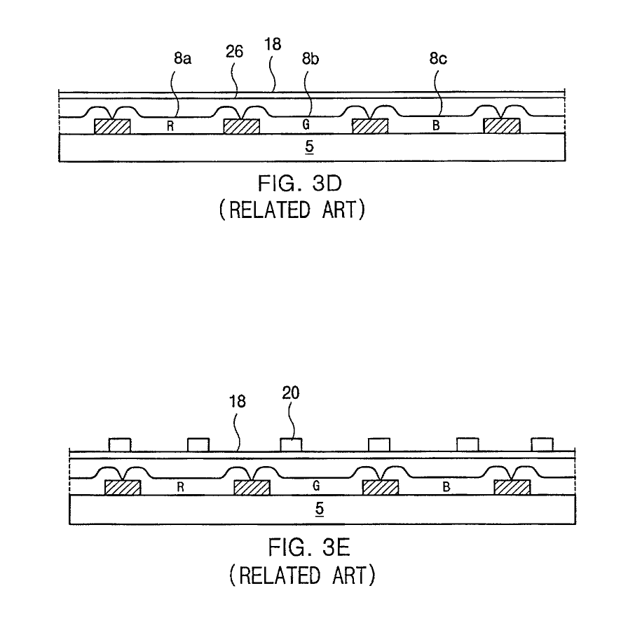

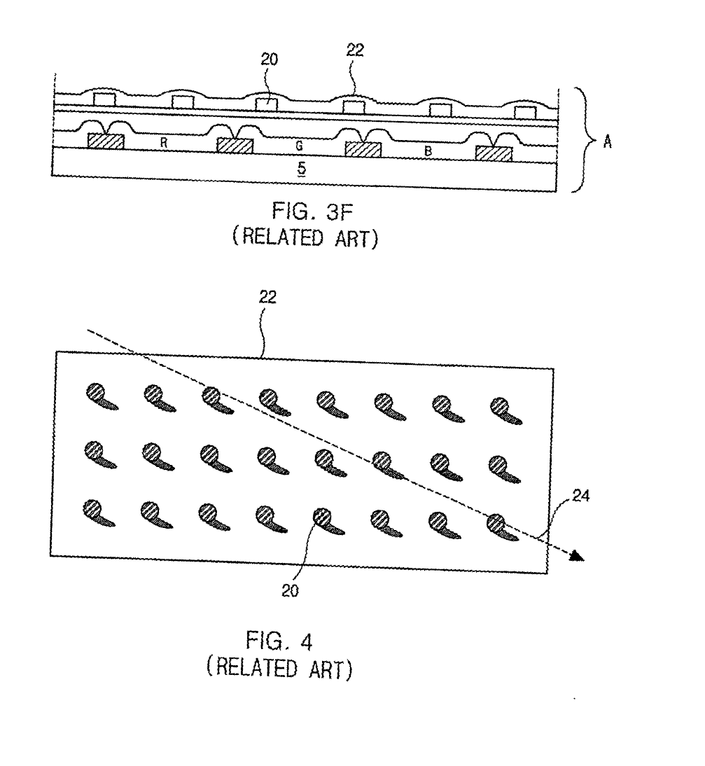

In FIG. 5C, a process of making an electrode on the color filter is performed. A transparent electrode 118 may be formed on the substrate 100. The transparent electrode 118 maintains a common voltage to drive the liquid crystal layer 14 with the pixel voltage maintained at the pixel electrode 17 on the array substrate 22 as shown in FIG. 1. Therefore, the common electrode 118 is formed on an entire surface of the substrate 100 by depositing and patterning a highly transparent conductive material such as indium-tin-oxide (ITO) and indium-zinc-oxide (IZO), for example. Accordingly, the overcoat layer 126 may be eliminated because it is not an essential constituent.

In FIG. 5D, an orientation film 120 is formed by deposition of a material such as polyimide, for example, on an entire surface of the substrate 100. Moreover, the material may be an acrylic resin. Subsequently, rubbing is performed along a definite direction after the deposition of the material.

In FIG. 5E, a definitive shape, dot shape for example, of spacer 122 may be formed at a desired region of the substrate 100 by spraying low viscous material mixed with a volatile solvent through an inkjet nozzle 124. The viscosity of the material forming the spacer may be within a range of about 3 cp˜20 cp, and more particularly within a range of about 3 cp˜10 cp. In this inkjet nozzle fabrication process, a height of the spacer is within about 1 μm˜5 μm and a top area of the spacer is within about 5×5 μm²˜10×10 μm². Moreover, a corresponding upper substrate may also be fabricated using the inkjet nozzle fabrication process.

FIG. 6 is a schematic plane view of an exemplary liquid crystal display panel according to the present invention.

When the upper substrate is formed according to the present invention, the array substrate illustrated in the FIG. 1 is attached, and the liquid crystal material is driven. As a result, a shadow or light leakage phenomenon, which results from generation of defects during rubbing of the orientation film 120 at the spacer 122 position in a conventional LCD device, does not occur.

Although the exemplary structure according to the present invention is illustrated with a color filter substrate, the present invention is not limited to the example and the spacer can be formed on the array substrate by the inkjet method in the case of the lower array substrate illustrated in FIG. 1. The present invention has some advantages. First, since extra chemical fabrication processes are eliminated or become unnecessary, throughput and yield of the device is improved due to the simplicity of the process. Second, since generation of defects in the orientation film by the spacers during the rubbing process does not occur, the quality of the liquid crystal display panel is improved due to absence of any light leakage.

It will be apparent to those skilled in the art that various modifications and variations can be made in the liquid crystal display devices of the present invention without departing from the spirit or scope of the invention. Thus, it is intended that the present invention covers the modifications and variations of this invention provided they come within the scope of the appended claims and their equivalents.

What is claimed is:

1. A method of fabricating a spacer for a liquid crystal display device, comprising the steps of:
forming a transparent electrode on a substrate;
forming an orientation film on the transparent electrode; and
forming a spacer on the orientation film by spraying a material through an inkjet nozzle.

2. The method according to claim 1, wherein the spacer is dot-shaped.

3. The color filter substrate according to claim 1, wherein the spacer is formed from at least a transparent organic material mixed with a volatile solvent.

4. The color filter substrate according to claim 3, wherein the transparent organic material is at least a resin of an acryl family.

5. The color filter substrate according to claim 3, wherein a viscosity of the transparent organic material is within a range of about 3 cp to 20 cp.

6. The color filter substrate according to claim 1, wherein a height of the spacer is within a range of about 1 μm to 5 μm and a top area of the spacer is within a range of about 5×5 μm² to 10×10 μm².

7. A color filter substrate, comprising:
a substrate;
a black matrix and a sub-color filter formed on the substrate;
a transparent electrode formed on the black matrix and the sub-color filter;
an orientation film on the transparent electrode; and
a spacer formed on the orientation film,
wherein an upper surface of the spacer is convex.

8. The color filter substrate according to claim 7, further comprising a planarization film on the black matrix and the sub-color filter.

9. The color filter substrate according to claim 7, wherein the spacer is formed from at least a transparent organic material mixed with a volatile solvent.

10. The color filter substrate according to claim 9, wherein the transparent organic material is at least a resin of an acryl family.

11. The color filter substrate according to claim 10, wherein a viscosity of the transparent organic material is within a range of about 3 cp to 20 cp.

12. The color filter substrate according to claim 7, wherein a height of the spacer is within a range of about 1 μm to 5 μm and a top area of the spacer is within a range of about 5×5 μm² to 10×10 μm².

13. A method of fabricating a color filter substrate, comprising the steps of:
forming a sub-color filter and a black matrix on a substrate;
forming a transparent electrode on the sub-color filter and the black matrix;
forming an orientation film on the transparent electrode; and
forming a spacer on the orientation film by spraying a material through an inkjet nozzle.

14. The method according to claim 13, further comprising the step of forming a planarization film on the sub-color filter and the black matrix.

15. The method according to claim 13, wherein the spacer is formed from at least a transparent organic material mixed with a volatile solvent.

16. The method according to claim 15, wherein the transparent organic material is an acrylic resin.

17. The method according to claim 16, wherein a viscosity of the transparent organic material is within a range of about 3 cp to 20 cp.

18. The method according to claim 13, wherein a height of the spacer is within a range of about 1 μm to 5 μm and a top area of the spacer is within a range of about 5×5 μm² to 10×10 μm².

19. The method according to claim 13, wherein the spacer is dot-shaped.

20. The method according to claim 13, wherein the spacer has a convex upper surface.
